(19) United States
(12) Patent Application Publication
(10) Pub. No.: US 2008/0223188 A1
(43) Pub. Date: Sep. 18, 2008

(54) Mitering saw system

(76) Inventors: Phillip A. Snartland, St. Cloud, MN (US); Aaron J. Zulkosky, St. Stephen, MN (US)

Correspondence Address: MERCHANT & GOULD PC, P.O. BOX 2903, MINNEAPOLIS, MN, 55402-0903, US

(21) Appl. No.: 11/725,184

(22) Filed: Mar. 16, 2007

(51) Int. Cl. B27B 27/06

(52) U.S. Cl. 83/471.3; 83/471

(57) ABSTRACT

A mitering saw system for cutting/shaping various materials including stone and other materials is disclosed herein. The saw system includes a first support member and a second support member extending generally vertically. A bridge longitudinally extending between the first and the second support members is configured to pivot relative to the first and second support members. A rotational blade is mounted on a carriage that is movably disposed on the bridge, the carriage configured to move longitudinally along the bridge. The bridge of the mitering saw system includes a pivot axis that is eccentric with respect to the longitudinal center axis of the bridge.

### TECHNICAL FIELD

The present disclosure relates generally to saw systems for cutting/shaping various materials including stone and other materials. More particularly, the present disclosure relates to saw systems including a mitering feature for performing angular cuts.

### BACKGROUND

FIGS. 1-4 diagrammatically illustrate a prior art gantry-type saw system 10 including a mitering feature. An example of a prior art gantry-type saw system is shown in U.S. Pat. No. 6,006,735, the entire disclosure of which is incorporated herein by reference.

In the system 10 illustrated in FIGS. 1-4, a cutting blade 12 is supported on a carriage 14. The carriage 14 is supported by and moves (e.g., slides) along a bridge 16, an endview of which is illustrated in FIGS. 1-4. Further views of the bridge 16 are shown in FIGS. 5-7. When a mitering operation is desired, the carriage 14 is pivoted about an axis going approximately through the geometric centerpoint 18 of the bridge 16 (i.e., longitudinal center axis). In FIGS. 3 and 4, the saw system 10 is illustrated in a pivoted position, wherein the blade 12 has been pivoted to an angle θ of about 45° from the vertical.

Still referring to FIGS. 1-4, the cutting blade 12 is moved toward and away from a work surface 24 by a vertical travel assembly including an actuator 20 (e.g., a hydraulic cylinder, motorized screw-type actuator, etc.). It should be noted that, in certain embodiments, the work surface 24 may be the top surface of a work table, the top surface of a floor if the work piece is place on the floor, or the top surface of a fixed raised platform.

FIG. 1 illustrates the cutting blade 12 at an uppermost position and FIG. 2 illustrates the cutting blade 12 in an actuated, lowermost position. In the depicted example, the actuator of the vertical travel assembly has a stroke length L_{S} of about 18 inches between the uppermost position and the lowermost position. As shown in FIG. 2, when the blade 12 has been fully actuated, the outer blade edge 22 is able to reach the work surface 24 and is able to perform a cut all the way through a workpiece 11 on the work surface 24. In the depicted example, the saw system is configured such that when the outer blade edge 22 is at the lowermost position, the blade edge is able to go past the work surface by a distance D_{P} of about 2.5 inches.

However, with the same actuator, when the saw system 10 is in a pivoted position for a mitering operation (e.g., at a 45° angle from the vertical) as seen in FIGS. 3 and 4, even in a fully actuated stage, the outer edge 22 of the blade 12 falls short of the work surface 24. As shown in FIG. 4, in the depicted example, the blade edge 22 falls short by a distance D_{S} of about 5.5 inches when at the lowermost position when the bridge has been pivoted 45° from the vertical.

Thus, even in a saw system such as the one illustrated in FIGS. 1 and 2 that has a vertical travel assembly which allows the blade 12 to reach the work surface 24 in the vertical position, in the pivoted position, the actuator 20 of the vertical travel assembly may not have the necessary stroke to perform a cut all the way through the workpiece 11 in a mitering operation at a 45° angle from the vertical. This is considered to be a shortcoming of the prior art systems.

Referring now to FIGS. 8-11, one solution that has been adopted by certain prior art systems is the use of a vertical travel assembly including actuator 20′ with a longer stroke length. In FIGS. 8-11, an actuator with a stroke length L_{S} of about 26 inches is shown. A vertical travel assembly with a longer travel stroke, however, not only adds to the cost, complexity, and size of the saw system 10′ but requires substantial design considerations relating to the static and dynamic forces required to support a larger assembly. As shown in FIGS. 9 and 11, in the depicted example, in order for the outer edge 22′ of the blade 12′ to reach the work surface 24′ when the bridge has been pivoted to an angle of 45°, the stroke length L_{S} of the actuator 20′ of the vertical travel assembly has to be such that it moves the blade edge 22′ past the work surface 24′ by a distance D_{P} of about 10.5 inches in a non-pivoted orientation.

Other solutions are desired.

### SUMMARY

One aspect of the present disclosure relates to a mitering saw system that includes a saw blade configured to pivot about an axis that is offset from the longitudinal centerline of the bridge supporting the blade.

In one example embodiment, the mitering saw system includes a first support member and a second support member extending generally vertically. A bridge longitudinally extending between the first and the second support members is configured to travel transversely along the first and second support members and is configured to pivot relative to the first and second support members. A blade is mounted on a carriage that is slidably disposed on the bridge, the carriage configured to move longitudinally along the bridge. The bridge of the mitering saw system includes a pivot axis that is eccentric with respect to the longitudinal center axis of the bridge.

Examples representative of a variety of inventive aspects are set forth in the description that follows. The inventive aspects relate to individual features as well as combinations of features. It is to be understood that both the forgoing general description and the following detailed description merely provide examples of how the inventive aspects may be put into practice, and are not intended to limit the broad spirit and scope of the inventive aspects.

### BRIEF DESCRIPTION OF THE DRAWINGS

FIG. 1 diagrammatically illustrates a prior art mitering saw in a vertical, unactuated position;

FIG. 2 illustrates the mitering saw of FIG. 1 in a downwardly actuated position;

FIG. 3 illustrates the mitering saw of FIG. 1 in a pivoted position for a mitering operation;

FIG. 4 illustrates the mitering saw of FIG. 1 in a pivoted and actuated position;

FIG. 5 illustrates a bridge structure used on prior art mitering saw systems;

FIG. 6 illustrates a close-up right perspective view of the rear end of the bridge structure of FIG. 5;

FIG. 7 illustrates a close-up left perspective view of the rear end of the bridge structure of FIG. 5;

FIG. 8 diagrammatically illustrates another example of a prior art mitering saw in a vertical, unactuated position, the mitering saw of FIG. 8 including a longer actuator than the mitering saw illustrated in FIGS. 1-4;

FIG. 9 illustrates the mitering saw of FIG. 8 in a downwardly actuated position;

FIG. 10 illustrates the mitering saw of FIG. 8 in a pivoted position for a mitering operation;

FIG. 11 illustrates the mitering saw of FIG. 8 in a pivoted and actuated position;

FIG. 12 illustrates a front left perspective view of a mitering saw system having features that are examples of inventive aspects in accordance with the principles of the present disclosure;

FIG. 12A illustrates the mitering saw system of FIG. 12 diagrammatically;

FIG. 13 illustrates a close-up view of a portion of the mitering saw system of FIG. 12;

FIG. 14 illustrates the portion of the mitering saw system shown in FIG. 12 from a front right perspective view;

FIG. 15 illustrates the portion of the mitering saw system shown in FIG. 12 from a rear left perspective view;

FIG. 16 illustrates the portion of the mitering saw system shown in FIG. 12 from a rear right perspective view;

FIG. 17 illustrates the mitering saw system of FIG. 12 in a pivoted orientation for a mitering operation;

FIG. 18 is a rear right perspective view of the mitering saw system of FIG. 17;

FIG. 19 illustrates a close-up view of a portion of the mitering saw system of FIG. 17;

FIG. 20 illustrates the portion of the mitering saw system shown in FIG. 19 from a front right perspective view;

FIG. 21 illustrates the portion of the mitering saw system shown in FIG. 19 from a rear left perspective view;

FIG. 22 illustrates the portion of the mitering saw system shown in FIG. 19 from a rear right perspective view;

FIG. 23 diagrammatically illustrates the mitering saw system of FIG. 12 having features that are examples of inventive aspects in accordance with the principles of the present disclosure in a vertical, unactuated position;

FIG. 24 illustrates the mitering saw of FIG. 23 in a downwardly actuated position;

FIG. 25 illustrates the mitering saw of FIG. 23 in a pivoted position for a mitering operation;

FIG. 26 illustrates the mitering saw of FIG. 23 in a pivoted and actuated position;

FIG. 27 illustrates the bridge structure configured for use on the mitering saw system of FIG. 12;

FIG. 28 illustrates a close-up left perspective view of the rear end of the bridge structure of FIG. 27;

FIG. 29 illustrates a close-up right perspective view of the rear end of the bridge structure of FIG. 27;

FIG. 30 diagrammatically illustrates another embodiment of a mitering saw system having features that are examples of inventive aspects in accordance with the principles of the present disclosure in a vertical, unactuated position;

FIG. 31 illustrates the mitering saw of FIG. 30 in a downwardly actuated position;

FIG. 32 illustrates the mitering saw of FIG. 30 in a pivoted position for a mitering operation;

FIG. 33 illustrates the mitering saw of FIG. 30 in a pivoted and actuated position;

FIG. 34 diagrammatically illustrates yet another embodiment of a mitering saw system having features that are examples of inventive aspects in accordance with the principles of the present disclosure in a vertical, unactuated position;

FIG. 35 illustrates the mitering saw of FIG. 34 in a downwardly actuated position;

FIG. 36 illustrates the mitering saw of FIG. 34 in a pivoted position for a mitering operation; and

FIG. 37 illustrates the mitering saw of FIG. 34 in a pivoted and actuated position.

### DETAILED DESCRIPTION

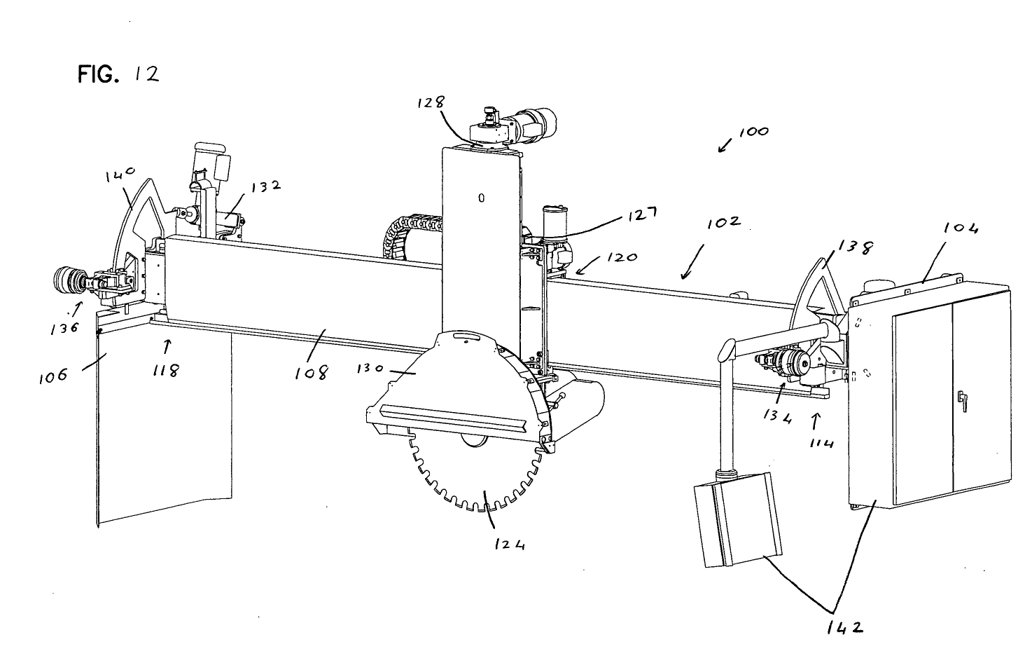

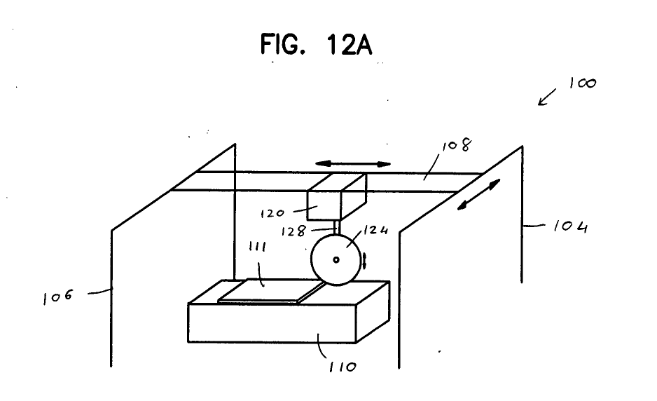

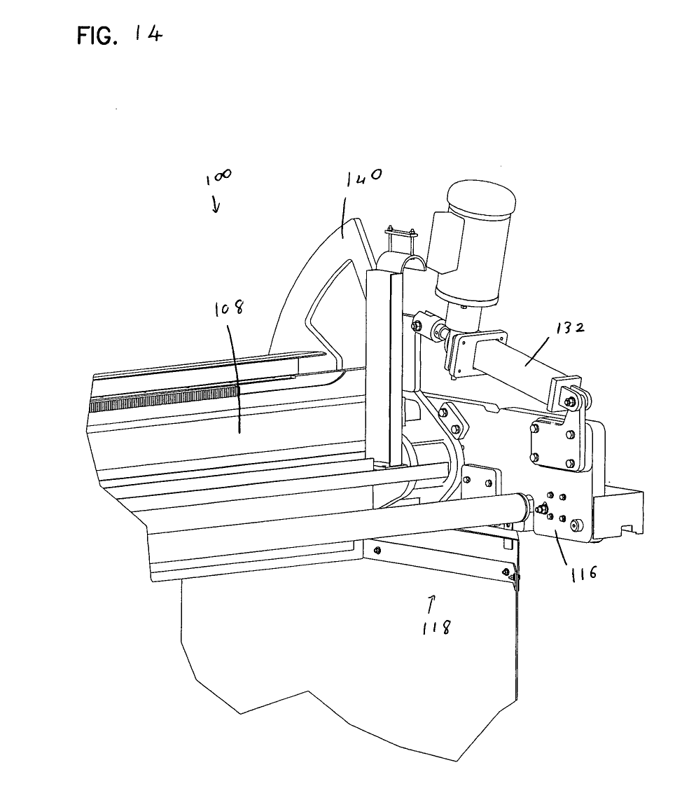

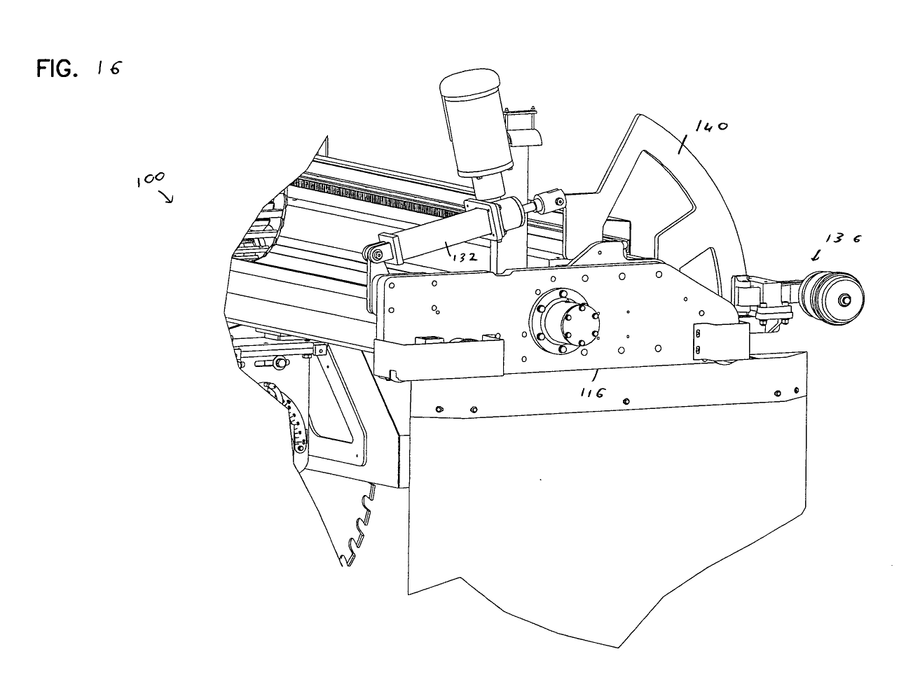

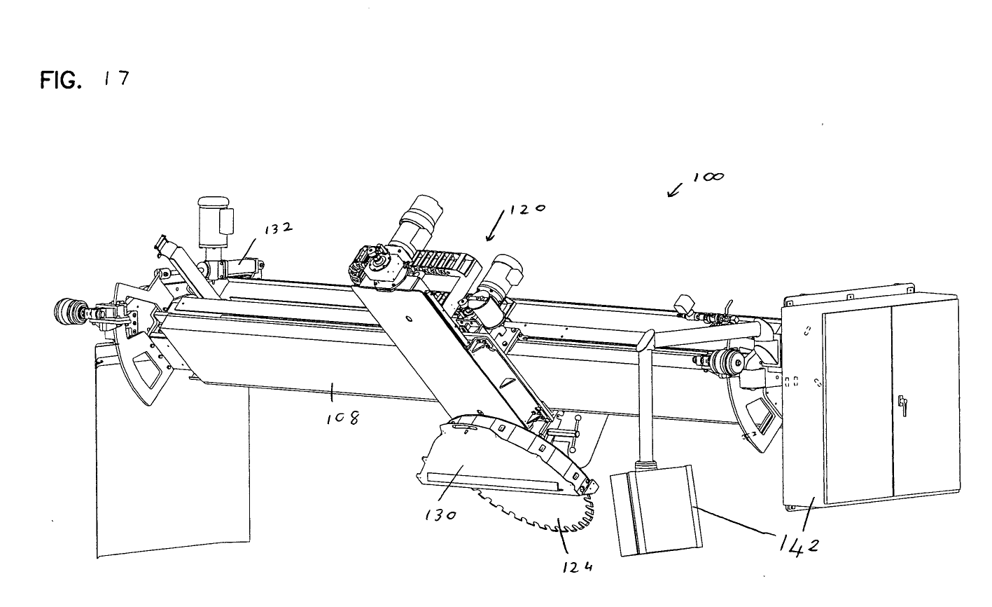

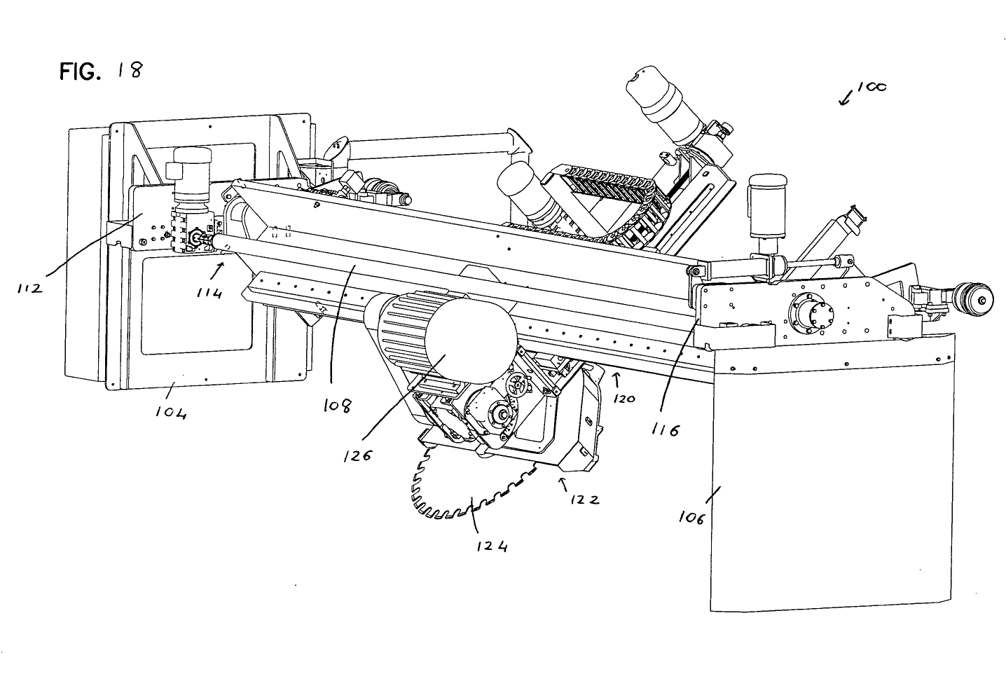

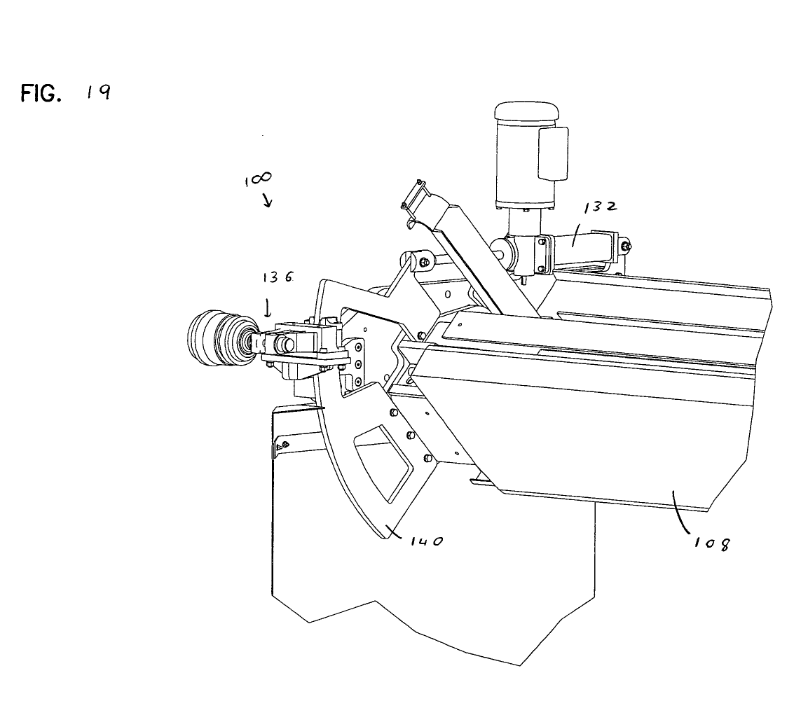

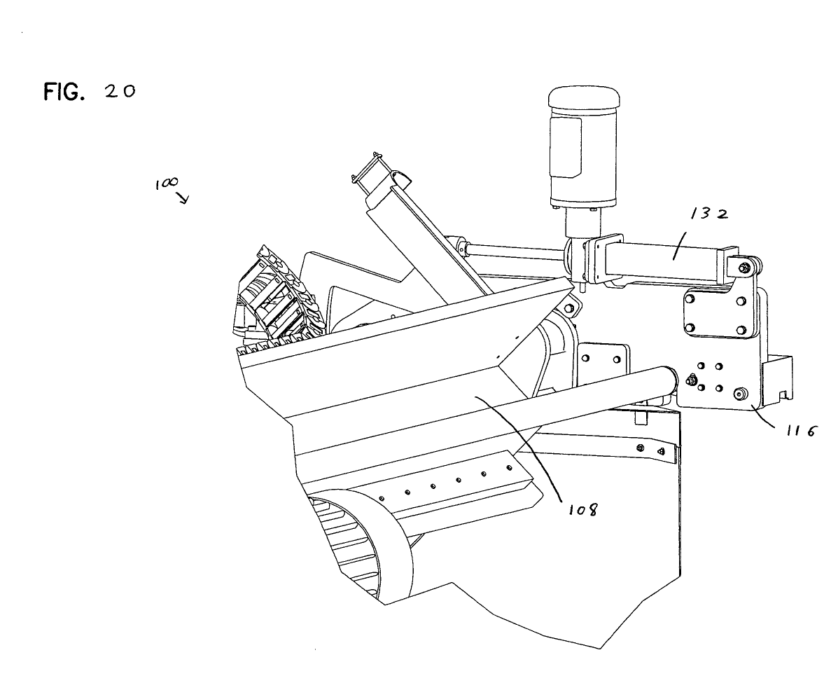

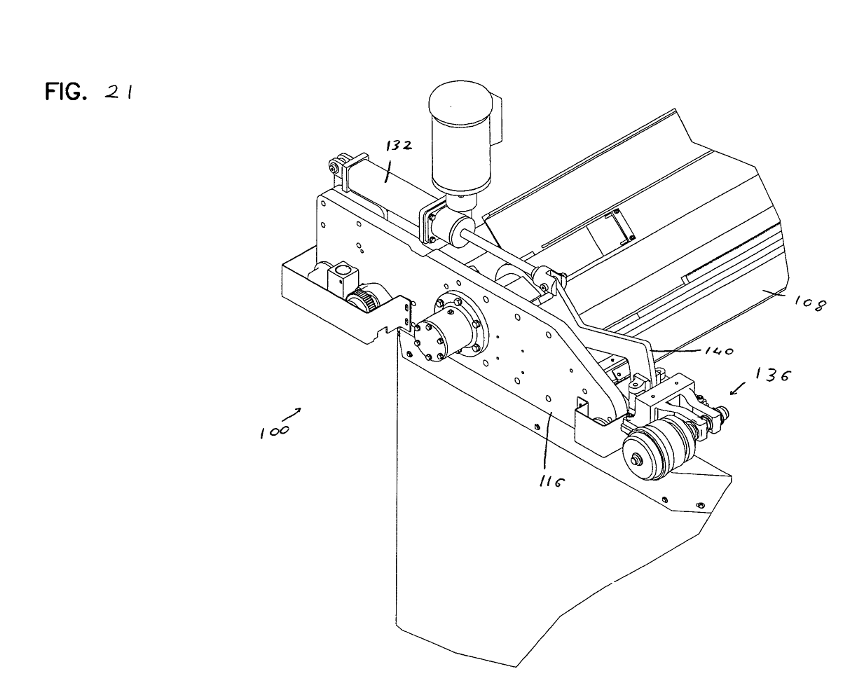

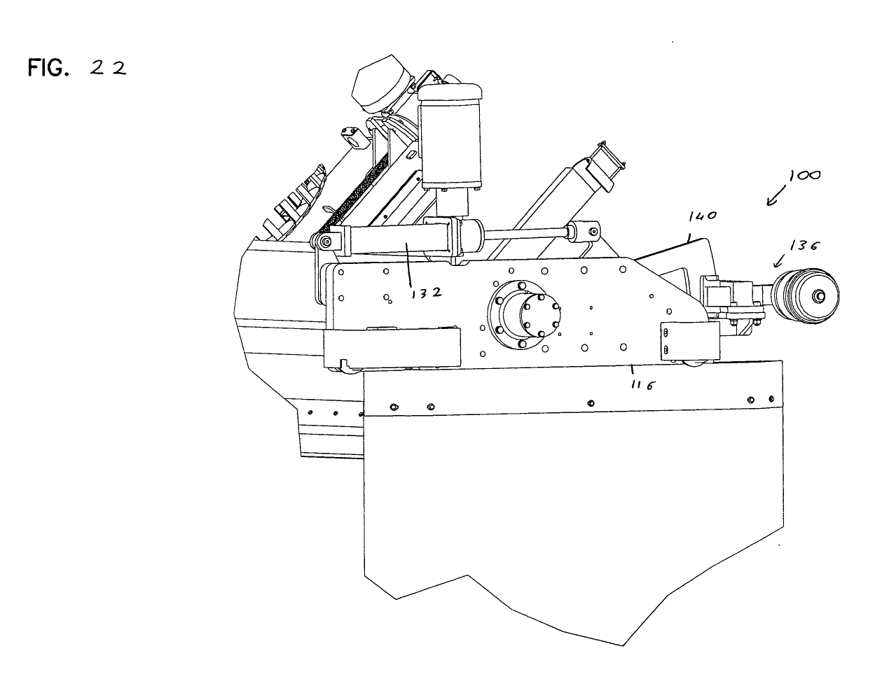

FIGS. 12-22 illustrate a mitering saw system 100 in accordance with the principles of the present disclosure. In certain embodiments, the saw system 100 may be used in the machining of articles manufactured from stone, glass, ceramic, metallic or other materials.

The saw system 100 may be of the gantry-type cutting machines known in the art. The features of a gantry-type cutting machine are shown diagrammatically in FIG. 12A. In one embodiment, the saw system 100 generally includes a gantry assembly 102 including a first support member 104, a second support member 106 and a bridge 108 extending longitudinally and configured to move transversely along the support members 104, 106 with respect to a work table 110. As discussed previously, although in the present embodiment, the work surface is depicted as the top surface of a work table 110, in other embodiments, the work surface can be the top surface of a floor if the work piece is placed on the floor, the top surface of a fixed raised platform, etc.

The bridge 108 is coupled to a first transverse travel member 112 at a front end 114 and to a second transverse travel member 116 at a rear end 118. The first and second transverse travel members 112, 116 are movable on top of the first and second support members 104, 106, respectively. In one embodiment, the movement may be accomplished by providing the transverse travel members 112, 116 with flanged roller assemblies for traveling back and forth along a flat rail member on one of the first and second support members 104, 106. It should be noted that, although the saw system 100 is depicted as a gantry-type cutting machine, the inventive aspects of the disclosure also apply to fixed-type bridge machines that do not move along gantry supports. For example, in fixed-bridge saws, the bridge may be constrained to move in the vertical direction, rather than the transverse direction, with respects to the gantry supports. A carriage may be mounted on the bridge that travels along the bridge.

In FIGS. 12 and 12A, in the depicted embodiment, the bridge 108 has mounted thereon a motor-driven carriage 120 which supports a rotary cutting blade assembly 122. The carriage 120 is configured to move longitudinally with respect to the bridge 108 over the work table 110, in a direction perpendicular to the direction of the movement of the bridge 108 with respect to the first and second transverse travel members 112, 116. The carriage 120 depicted is known in the art, being of the type used in conventional numerically controlled or non-numerically controlled, manual cutting machines.

Still referring to FIGS. 12-22, a rotary cutting blade 124 of the blade assembly 122 is connected to a blade motor 126, for example, of the brushless type, for bringing the cutting blade 124 into a rotating motion. The blade assembly 122 is operatively connected to a vertical travel assembly 127 having an actuator 128 configured to move the blade 124 toward and away from a workpiece 111 positioned on the work table 110 (see FIGS. 12A and 23-26). The blade assembly 122 includes a cover 130 mounted over the blade 124.

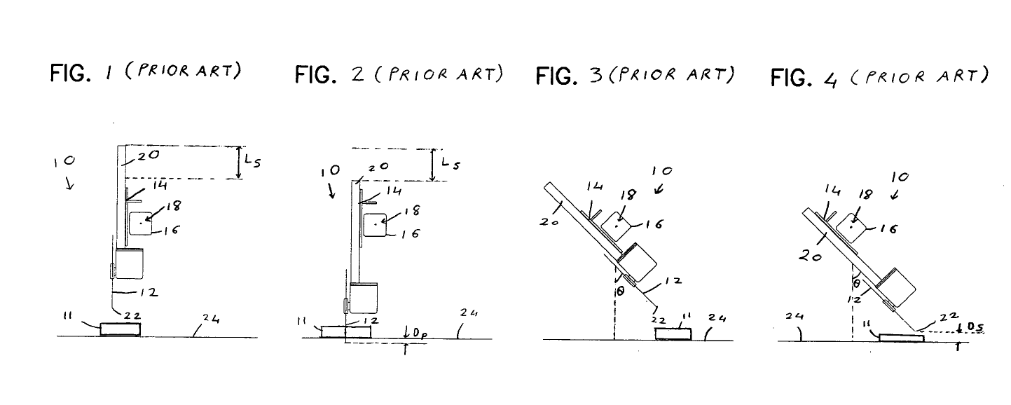

As depicted in FIGS. 1 7-22, the saw system 100 of the present disclosure is configured to perform a mitering operation when angled cuts are desired on the workpiece. In one embodiment, the saw system 100 of the present disclosure is able to perform cuts at angles between 0° and at least 45° from a vertical plane. As discussed above, in conventional miter saw systems, the bridge is pivoted about a pivot axis that longitudinally extends generally along a centerline of the bridge. In the saw system 100 of the present disclosure, the bridge 108 is pivoted about an axis that is positioned offset from the centerline 125 of the bridge 108, further details of which will be described below. When a mitering operation is desired, the bridge 108 is pivoted by a pivot actuator 132 to the desired angle. As shown in the Figures, the miter saw system 100 of the present disclosure includes brake assemblies 134, 136 at both the front and the rear ends 114, 118 of the bridge 108. The brake assemblies 134, 136 are configured to contact pivot plates 138, 140 located at both ends 114, 118 of the bridge 108 and lock the bridge 108 in the desired angular position for mitering. Once pivoted, the actuator 128 is used to move the blade assembly 122 toward and away from a workpiece 111 on the work table 110.

As shown in FIGS. 12, 17, and 18, in one embodiment, the saw system may include a control station 142. The control station 142 includes a host of input/output devices for operator control, and an internally disposed microprocessor controller having a memory and a controller. The memory is provided for storing data representing any number of predetermined cut operations. The controller may be communicatively coupled to the saw system 100 for selectively controlling the saw system 100 to create any number of predetermined cuts on the workpiece 111. Via the control station 142, a large number of operations and their parameters can be directed, including, but not limited to, the movement of the gantry assembly 102 including the transverse movement of the bridge 108 along the first and second support members 112, 116, the movement of the carriage 120 along the bridge 108, the vertical or angular actuation of the carriage 120, the pivotal actuation of the bridge 108, the rotation of the blade 124, the rotational speed of the blade 124, etc. The inventive aspects of the present disclosure may also be used on non-computerized saw systems.

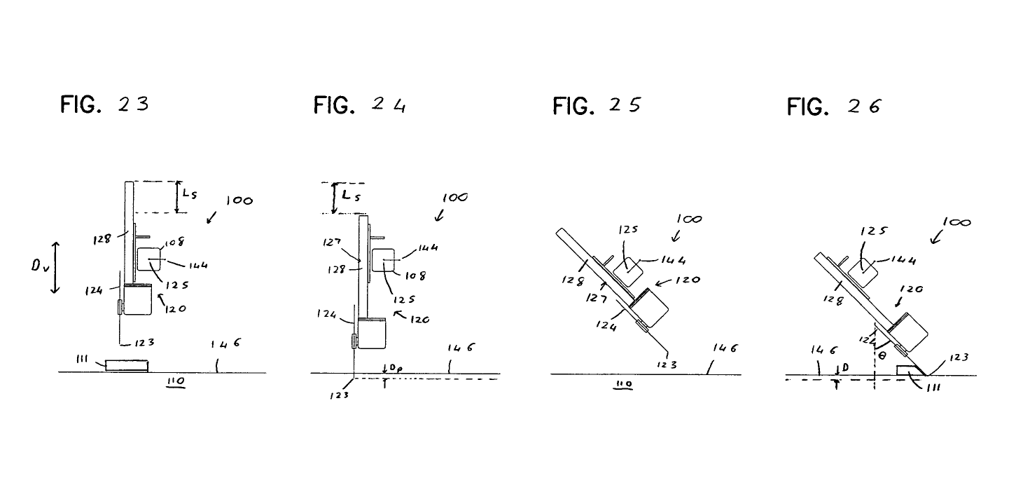

Referring now to FIGS. 23-26, the operation of the saw system 100 of the present disclosure is shown diagrammatically. As shown, the pivot point 144 for the system 100 is located offset from the centerline 125 of the bridge 108. This feature allows the carriage 120 of the system 100 to not only pivotally rotate, but also translate along a vertical direction D_{V} such that the edge 123 of the blade 124 is able to reach the top surface 146 of the work table 110 during a mitering operation. As shown in FIG. 26, even when the carriage 120 has been pivoted to an angle of 45°, the blade 124 is able to perform a cut all the way through the workpiece 111 on the work table 110. The saw system 100 of the present disclosure is such that the same actuator 128 that has the necessary stroke length to able to reach the top surface 146 of the table 110 in the vertical direction D_{V} can also reach the top surface 146 of the table 110 in the pivoted position at 45°.

Still referring to FIGS. 23-26, in one embodiment, the actuator 128 of the vertical travel assembly has a stroke length L_{S} of about 18 inches. With such a stroke length L_{S}, as discussed above with respect to the example prior art system of FIGS. 1-4, the blade edge 123 goes past the top surface 146 of the work table 110 by a distance D_{P} of about 2.5 inches. Due to the pivot configuration of the saw system 100, the vertical travel assembly 127, even though allowing the blade edge 123 to pass the top surface 146 of the work table 110 by only 2.5 inches, is able to reach the blade edge 123 to the work table 110 when in a pivoted position of 45°. In prior art systems, such as the system 10 shown in FIGS. 1-4, the blade edge 123 would fall short of the work table 110 with such a vertical travel assembly.

Still referring to FIGS. 23-26, in one embodiment of the saw system, the vertical distance D between the lowermost position of the outer blade edge 123 when the bridge 108 has been pivoted 0° from a vertical plane and the lowermost position of the outer blade edge 123 when the bridge 108 has been pivoted 45° from a vertical plane is at most 35% of the actuation stroke length L_{S}.

In another embodiment, the vertical distance D between the lowermost position of the outer blade edge 123 when the bridge 108 has been pivoted 0° from the vertical plane and the lowermost position of the outer blade edge 123 when the bridge 108 has been pivoted 45° from the vertical plane is between 1% and 30% of the actuation stroke length L_{S}.

In yet another embodiment of the saw system 100, the vertical distance D between the lowermost position of the outer blade edge 123 when the bridge 108 has been pivoted 0° from the vertical plane and the lowermost position of the outer blade edge 123 when the bridge 108 has been pivoted 45° from the vertical plane is between 5% and 20% of the actuation stroke length L_{S}.

In yet another embodiment of the saw system 100, the vertical distance D between the lowermost position of the outer blade edge 123 when the bridge 108 has been pivoted 0° from the vertical plane and the lowermost position of the outer blade edge 123 when the bridge 108 has been pivoted 45° from the vertical plane is between 9% and 15% of the actuation stroke length L_{S}.

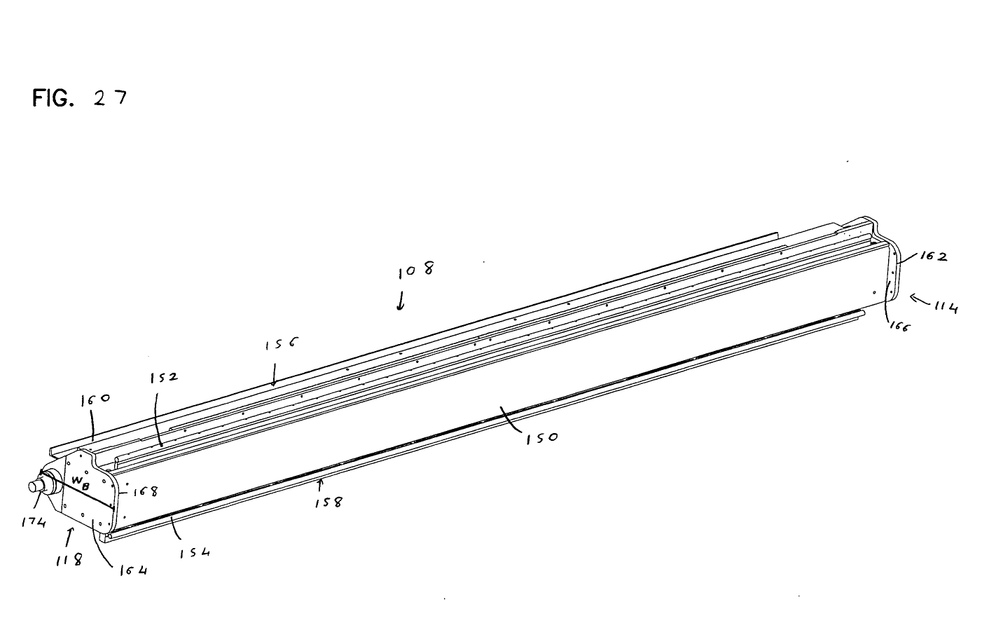

The bridge 108 configured for use with the saw system 100 of the present disclosure is shown in FIGS. 27-29. As shown, the bridge 108 includes an elongated body 150 with the front end 114 and the rear end 118. The body includes a width W_{B}. In one embodiment, the width W_{B} is about 12 inches.

The body 150 includes longitudinal rails 152, 154 on top and bottom ends 156, 158 of the body 150, respectively. The body 150 also includes a carriage movement structure 160. The carriage 120 with the rotary blade 124 moves along the top and bottom rails 152, 154 by the carriage movement structure 160. It should be noted that the carriage movement structure 160 may include a gear rack, a roller chain mechanism, a screw mechanism, a friction wheel, or other structures known in the art.

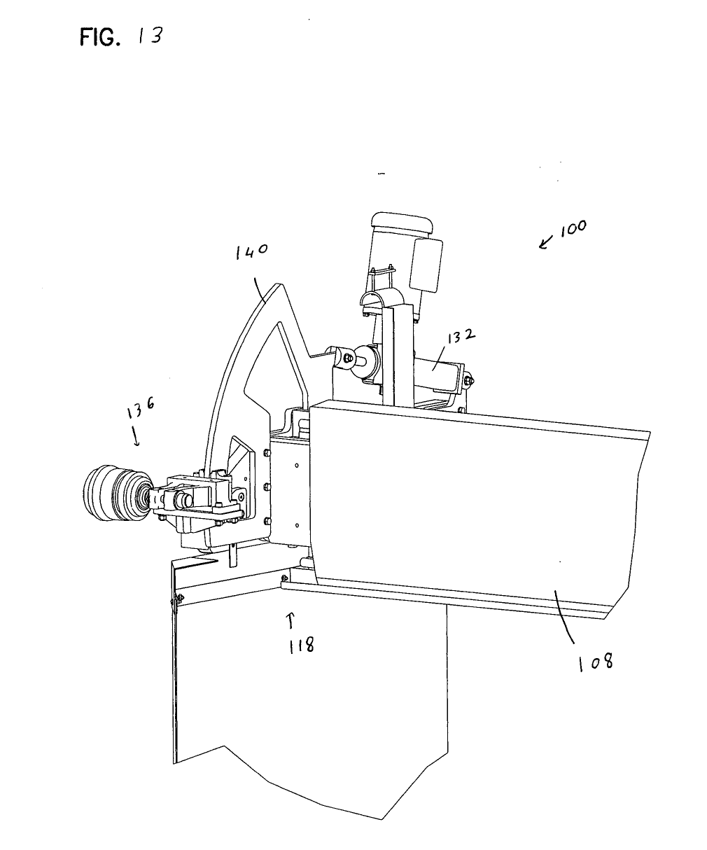

At the front and rear ends 114, 118 of the body 150 are located a first mounting plate 162 and a second mounting plate 164. The first and the second mounting plates 162, 164 define first and second flanges 166, 168, respectively. The flanges 166, 168 include a plurality of holes 170 used for mounting the pivot plates 138, 140 to the bridge 108 (see FIGS. 13 and 19).

Still referring to FIGS. 27-29, a pivot pin 174 of the bridge 108 is located offset from the centerline 125 of the body 150. In one embodiment, the centerpoint of the pivot pin 174 has been horizontally offset from the centerpoint of the bridge 108 by about 8.5 inches. In another embodiment, the centerpoint of the pivot pin 174 has been horizontally offset from the centerpoint of the bridge 108 by about 60-90% of the width W_{B} of the bridge body 150. In another embodiment, the centerpoint of the pivot pin 174 has been horizontally offset from the centerpoint of the bridge 108 by about 65-85% of the width W_{B} of the bridge body 150. In yet another embodiment, the centerpoint of the pivot pin 174 has been horizontally offset from the centerpoint of the bridge 108 by about 70-75% of the width W_{B} of the bridge body 150.

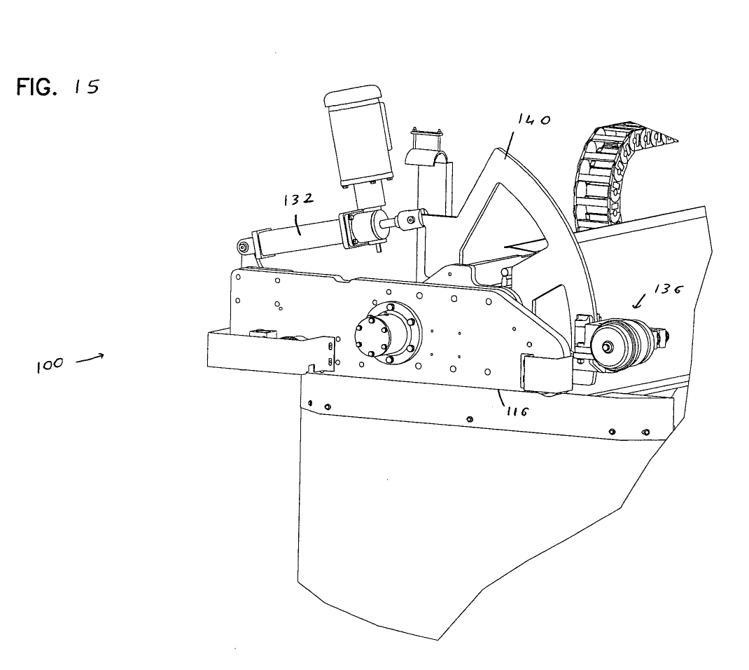

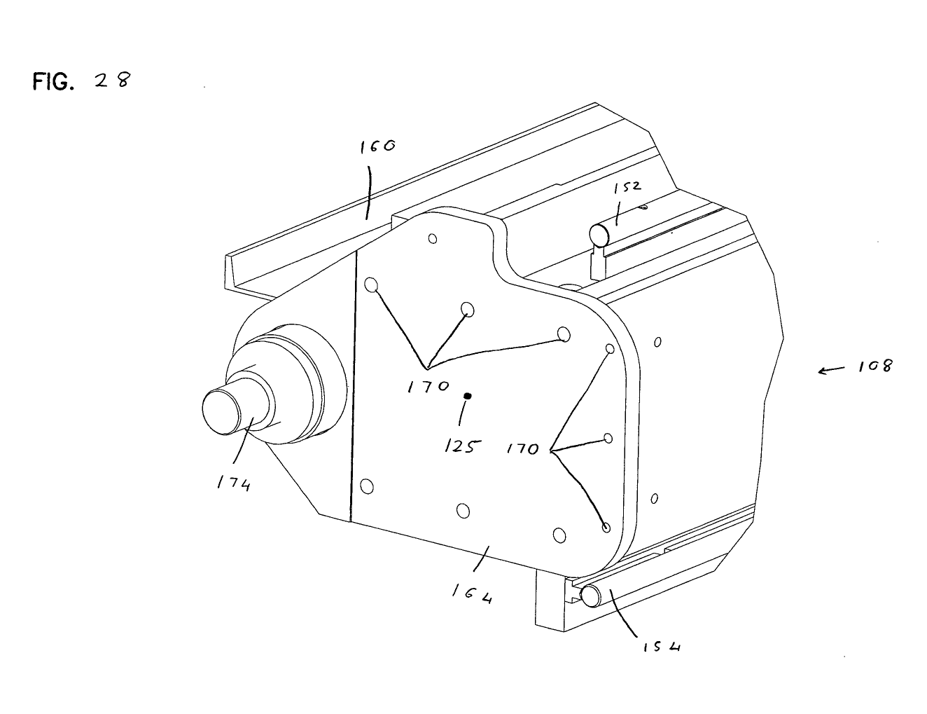

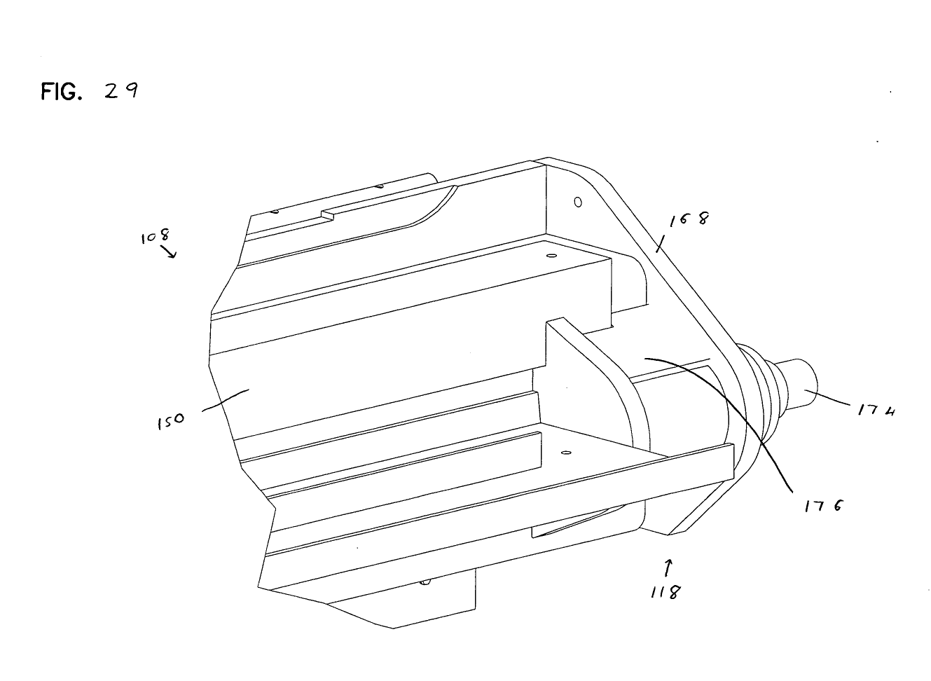

Referring to only one end (e.g., rear end 118) of the bridge 108, the pivot pin 174 is attached to the mounting plate 168 of the bridge 108. As shown in FIG. 29, the bridge 108 includes a reinforcement structure 176 extending between the body 150 of the bridge and the portion of the mounting plate 168 supporting the pivot pin 174. The pivot pin 174 of the bridge 108, in turn, is rotatably coupled to the transverse travel member 116, as shown in FIGS. 15, 16, 18, 21, and 22. It should be noted that the front end 114 and the rear end 118 of the bridge 108 including the pivot pins are configured similarly.

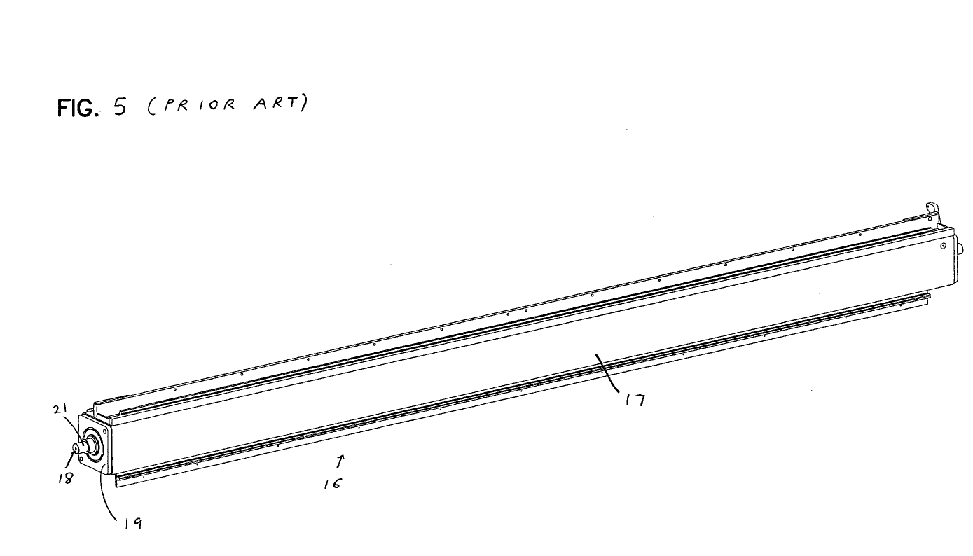

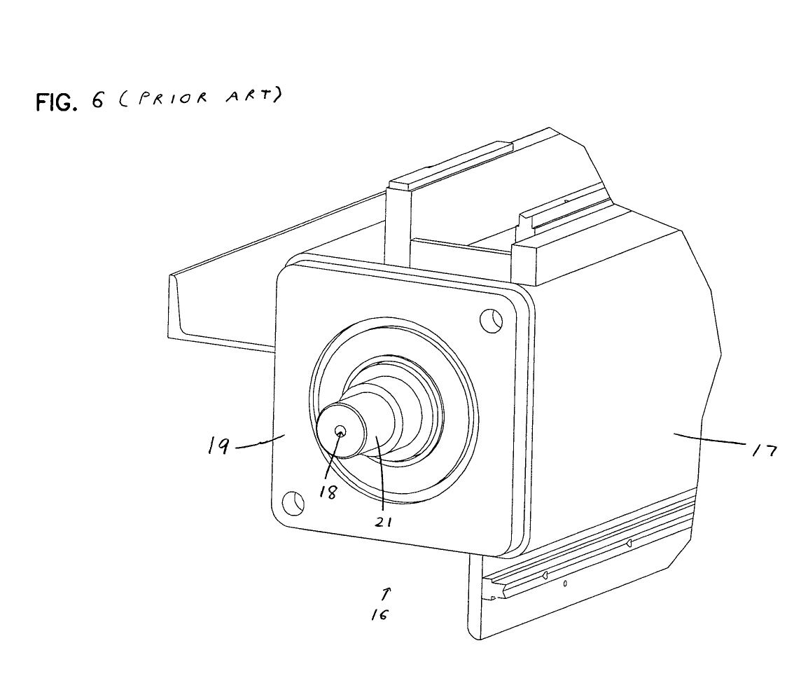

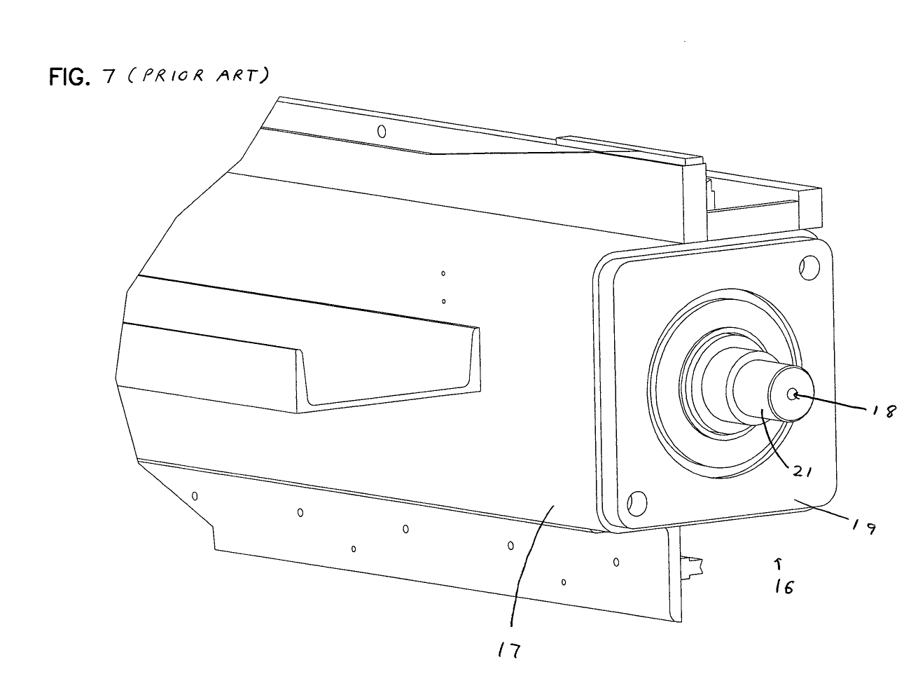

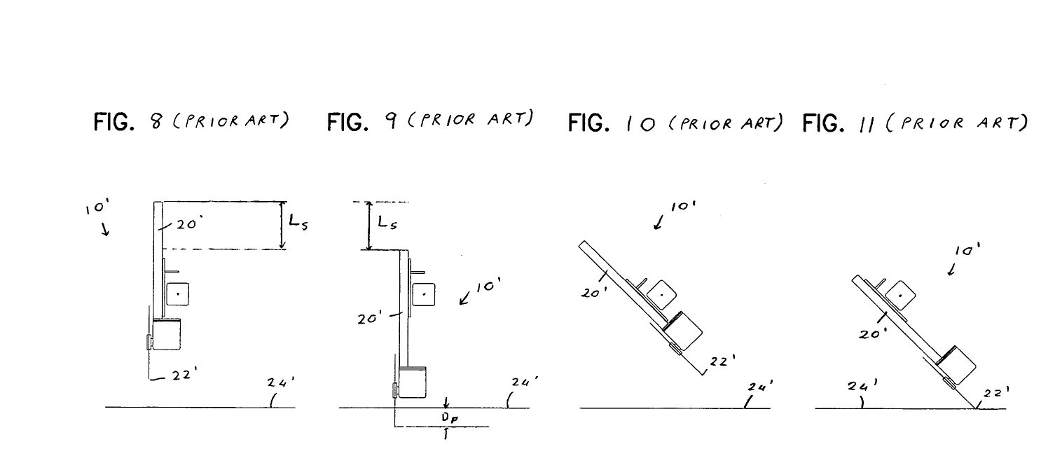

As shown in FIGS. 5-7, bridge 16 used in prior art systems includes a body 17 with a generally square cross-sectional configuration 19, wherein the pivot pin 21 is located approximately at the center of the square 19. When the bridge 16 of a prior art system 10 is pivoted, the carriage 14 supporting the blade 12 simply tilts and does not experience a translational motion. In contrast, as shown diagrammatically in FIGS. 23-26, when the bridge 108 of the system 100 of the present disclosure is pivoted, the carriage 120, not only rotates, but, also experiences a translational motion similar to a swinging motion. In this manner, when the blade 124 is actuated toward the work piece, the edge 123 of the blade 124 ends up reaching the top surface 146 of the work table 110 since the blade 124 experiences vertical displacement toward the work table 110 in addition to pivotal rotation.

Referring to FIGS. 30-33, a second embodiment of a mitering saw system 200 having features that are examples of inventive aspects in accordance with the principles of the present disclosure is shown. The saw system 200 of FIGS. 30-33 is similar to a prior art saw system 10 illustrated in FIGS. 1-4, except that the saw system 200 includes a longer blade arm 201 connecting the rotary blade 224 to the main housing 203 of the blade assembly 222. This configuration moves the pivot point 244 further away from the bottommost outer edge 223 of the blade 224 when compared to prior art saw systems. Thus, by moving the pivot point 244 further away from the blade 224, the resulting motion of the carriage 220 is a swinging motion that includes a translational component in addition to a rotational component. In the first embodiment of the saw system 100 illustrated in FIGS. 12-29, by moving the pivot point 144 away from the centerline 125 of the bridge 108, the pivot point 144 is moved away from the blade 124 and thus a translational motion is obtained when the bridge 108 is pivoted. In that embodiment, the pivot point 144 is physically moved away from the blade 124 rather than the blade being moved away from the pivot point as in the embodiment of FIGS. 30-33.

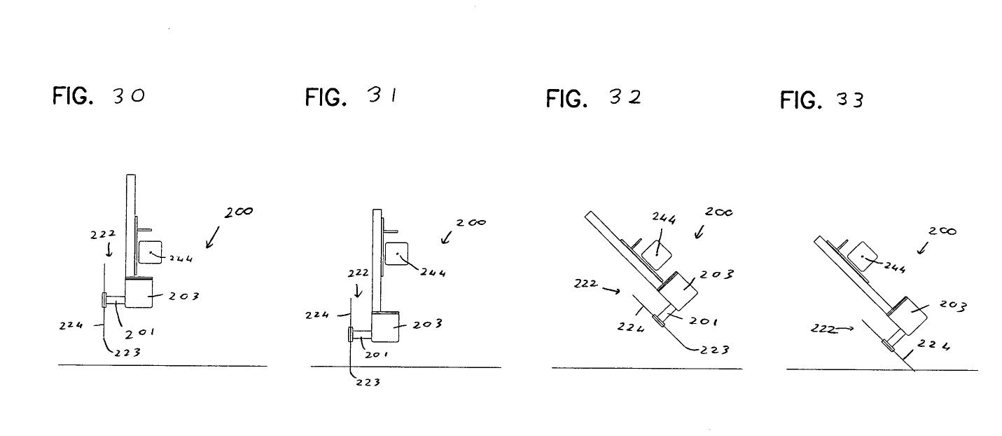

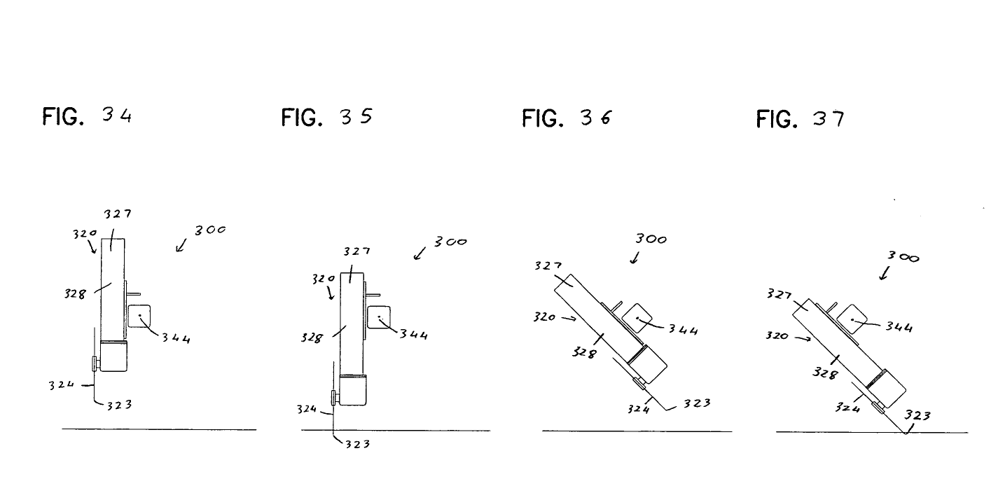

A third embodiment of a mitering saw system 300 is shown in FIGS. 34-37. In the saw system 300 illustrated in FIGS. 34-37, the portion 327 of the carriage 320 supporting the actuator 328 is made wider in comparison to the prior art saw system 10 shown in FIGS. 1-4. As a result, the pivot point 344 has been moved away from the bottommost outer edge 323 of the saw blade 324 when compared to prior art systems. Thus, by moving the pivot point 344 further away from the blade 324, the resulting motion of the carriage 320 is a swinging motion that includes a translational component in addition to a rotational component.

The above specification provides examples of how certain inventive aspects may be put into practice. It will be appreciated that the inventive aspects can be practiced in other ways than those specifically shown and described herein without departing from the spirit and scope of the inventive aspects.

We claim:

1. A saw system comprising:
a first support member extending generally in a vertical direction;
a second support member extending generally in the vertical direction;
a bridge longitudinally extending between the first and the second support members;
a carriage movably mounted on the bridge, the carriage configured to move longitudinally along the bridge;
a rotational blade mounted on the carriage; and
an actuator for moving the blade toward and away from a workpiece positioned between the first and the second support members;
wherein the bridge is configured to pivot with respect to the first and second support members along a pivot axis, the pivot axis running generally parallel to a longitudinal axis going through the geometric centerline of the bridge, the pivot axis being offset from the longitudinal axis such that when the bridge is pivoted, the pivotal movement of a point located on the geometric centerline of the bridge includes a rotational motion about the pivot axis and a translational motion along a vertical direction.

2. The saw system of claim 1, wherein the bridge is configured to move transversely along the first and second support members.

3. The saw system of claim 1, wherein the bridge is pivotable to at least about 45° from the vertical direction.

4. The saw system of claim 1, wherein the bridge includes a pivot pin protruding outwardly from at least one end of the bridge, the pivot pin positioned offset from the longitudinal axis of the bridge.

5. The saw system of claim 1, wherein the pivot axis is horizontally offset from the longitudinal axis going through the geometric centerline of the bridge.

6. The saw system of claim 5, wherein the bridge defines a width in the horizontal direction, the pivot axis being offset from the longitudinal axis going through the geometric centerline of the bridge by about 70% to 75% of the width of the bridge.

7. A saw system comprising:
a first support member extending generally vertically;
a second support member extending generally vertically;
a bridge longitudinally extending between the first and the second support members, the bridge configured to pivot relative to the first and second support members;
a carriage movably mounted on the bridge, the carriage configured to move longitudinally along the bridge;
a rotational blade mounted on the carriage; and
an actuator for moving the blade toward and away from a workpiece positioned between the first and the second support members;
wherein the bridge includes a pivot axis that is eccentric with respect to the longitudinal center axis of the bridge.

8. The saw system of claim 7, wherein the bridge is configured to move transversely along the first and second support members.

9. The saw system of claim 7, wherein the bridge is pivotable to at least about 45° from a vertical direction.

10. The saw system of claim 7, wherein the bridge includes a pivot pin protruding outwardly from at least one end of the bridge, the pivot pin positioned offset from the longitudinal center axis of the bridge.

11. The saw system of claim 7, wherein the pivot axis is horizontally offset from the longitudinal center axis of the bridge.

12. The saw system of claim 11, wherein the bridge defines a width in the horizontal direction, the pivot axis being offset from the longitudinal center axis of the bridge by about 70% to 75% of the width of the bridge.

13. A saw system comprising:
a first support member;
a second support member;
a bridge extending longitudinally between the first and the second support members, the bridge configured to pivot relative to the first and second support members between about 0° and at least 45° from a vertical plane;
a carriage movably mounted on the bridge, the carriage configured to move longitudinally along the bridge;
a rotational blade mounted on the carriage, the blade defining an outer edge; and
an actuator configured to move the blade between an uppermost position and a lowermost position, the actuator including an actuation stroke length defined between the uppermost position and the lowermost position of the blade;
wherein the vertical distance between the lowermost position of the outer blade edge when the bridge has been pivoted 0° from the vertical plane and the lowermost position of the outer blade edge when the bridge has been pivoted 45° from the vertical plane is at most 35% of the actuation stroke length.

14. The saw system of claim 13, wherein the vertical distance between the lowermost position of the outer blade edge when the bridge has been pivoted 0° from the vertical plane and the lowermost position of the outer blade edge when the bridge has been pivoted 45° from the vertical plane is between 1% and 30% of the actuation stroke length.

15. The saw system of claim 14, wherein the vertical distance between the lowermost position of the outer blade edge when the bridge has been pivoted 0° from the vertical plane and the lowermost position of the outer blade edge when the bridge has been pivoted 45° from the vertical plane is between 5% and 20% of the actuation stroke length.

16. The saw system of claim 15, wherein the vertical distance between the lowermost position of the outer blade edge when the bridge has been pivoted 0° from the vertical plane and the lowermost position of the outer blade edge when the bridge has been pivoted 45° from the vertical plane is between 9% and 15% of the actuation stroke length.

17. The saw system of claim 13, wherein the bridge includes a pivot pin protruding outwardly from at least one end of the bridge, the pivot pin positioned offset from a longitudinal center axis of the bridge.

18. The saw system of claim 13, wherein the bridge is configured to move transversely along the first and second support members.

19. A bridge configured to be pivotally mounted on a saw system including a first vertically extending support member and a second vertically extending support member, wherein the bridge is configured to extend longitudinally between the first and second support members and configured to pivot relative to the first and second support members, the bridge configured to support a carriage supporting a blade, the bridge comprising:
a body including a first end, a second end, and a length extending between the first end and the second end;
a longitudinal center axis extending through the geometric centerline of the bridge; and
a pivot pin protruding outwardly from the first end of the bridge, the pivot pin generally parallel to the longitudinal center axis and positioned offset from the longitudinal center axis of the bridge.

20. The bridge of claim 19, wherein the bridge defines a width in the horizontal direction, the pivot pin being offset from the longitudinal center axis of the bridge by about 70% to 75% of the width of the bridge.
